(19) United States
(12) Patent Application Publication
(10) Pub. No.: US 2004/0250138 A1
(43) Pub. Date: Dec. 9, 2004

(54) Graphical event-based password system

(76) Inventor: Jonathan Schneider, Thornhill (CA)

Correspondence Address: JONATHAN SCHNEIDER, 133 RODEO DRIVE, THORNHILL, ON, L4J 4Y6, CA

(21) Appl. No.: 10/418,266

(22) Filed: Apr. 18, 2003

(51) Int. Cl. H04L 9/32

(52) U.S. Cl. 713/202

(57) ABSTRACT

An event-based graphical password system displays sets of images and requires the user to select an image corresponding with an event in a story the user imagines. This causes a second set of images to be displayed, which requires the user to select a second image, again corresponding with an event in a story the user imagines. This causes a third set of images to be displayed which requires the user to select a third image, against corresponding with an event in a story the user imagines. Codes representing these images are placed in a series (or virtual) scene registers, which together, represent the password selected by the user.

### FIELD OF THE INVENTION

The present invention relates generally to processing systems and specifically relates to password systems used to allow access to particular resources, generally with computer based machines.

### BACKGROUND OF THE INVENTION

Password systems have been used with computer based machines for many years. A typical password may be, for example, a four-digit number, for example ‘2535’. In such a case if one wants to start using a particular computer program or for the computer based machine to perform a certain action, the machine asks a password, and if in this case, the number ‘2535’ is entered (usually via a keyboard or keypad, but equivalent ways may be via speaking a word into a language recognition system, etc), then the particular computer program or action starts. If the wrong password, for example in this case, ‘2536’, was entered, then the particular program or particular action would not occur, and the user may (or may not) receive an error message from the computer.

Many password systems exist. While a four-digit number is a popular system, used at automatic bank machines, for example, many other password systems use longer numbers or also allow a wider variety of alphanumeric characters. More possibilities in a password, do allow better security since more incorrect choices must be attempted to arrive at the password by such attempts. However, the problem with all such types of password systems, is that the user is expected to memorize his/her password. A four-digit password is work enough to memorize, a longer password is even more difficult. As well, a user may have many such passwords to memorize as required by many different computer programs or computer-based machines he/she normally uses. What typically happens in such cases is that persons write their passwords down on pieces of paper they keep on their desks or in their pockets, and security is badly compromised. Or to avoid needing to write their passwords down, persons may choose easy to remember passwords such as their pet's name or the last four digits of their telephone number, etc. Again, security is again compromised, since this information is usually readily available to others who may want to try this information as a possible password choice for that individual. (Another reason why security is compromised in such cases is because it is often possible to program another computer system to try all the four-digit numbers or all the words in a dictionary, etc, in order to inappropriately enter a password protected system.) As daily life in a technological society involves use or more and more computer-based machinery, and the consequences of using such computer-based machinery becomes more important, the issue of memorizing passwords or using simple words as passwords, becomes more and more serious.

Many inventors have considered this issue of memorizing passwords, and the issue of password security, and have come up with many alternative password systems, many involving biometric information, such as a user's fingerprint or the pattern of a user's iris or retina or voice or face. However, there are privacy concerns with regards to using biometric information in a password system. As well, using biometric information in a password system requires the addition of specialized, and often costly, hardware equipment to the computer system.

Since it appears that persons memorize images differently than sequences of numbers or letters, and since an image is harder for another computer system to simply, other inventors have considered replacing alphanumeric passwords with image passwords. For example, Blonder, U.S. Pat. No. 5,559,961, presents ‘a user with a predetermined image on a visual display and is required to point to (eg, touch) one or more predetermined positions on the displayed image (referred herein as “tap regions”) in a predetermined order as a way of indicating his or her authorization to access the resource’. For example, Bodnar, U.S. Pat. No. 6,278,453, discusses a graphical password methodology for microprocessor device accepting non-alphanumeric user input. In both these cases, however, although it may be somewhat easier for a user to recall images than strings of numbers or letters, and thus make these password systems somewhat more successful over ordinary alphanumeric password systems, it still is not easy enough to remember the graphical images. However, unpublished work done by the present inventor, Jonathan Schneider, shows that users still have considerable difficulty memorizing a sequence of several images or portions of images, and that such graphical password systems do not overcome the problem of having users memorize their many passwords.

### SUMMARY OF THE INVENTION

The present invention describes both a method and an apparatus which overcomes the problem of having users memorize their many passwords.

While it is indeed difficult to memorize many alphanumeric password strings, and perhaps only somewhat easier to memorize many images to be used as various passwords, persons are able to almost effortless memorize sequence of events of daily life and in finding one's way around a building or a region. After watching a television program, for example, it is quite easy to remember what the characters did and where they went. Indeed, one is able to remember quite easily multiple such television programs, or equivalent events of daily life. The present invention exploits this aspect of human cognition to create both a method and an apparatus which overcomes the problem of the difficulty of memorizing many different passwords.

In the present invention, on a User Output Device, typically a computer monitor, the user is shown a group (or series) of images. The user is prompted to chose an image and imagine a story concerning that image. For example, the user could initially be shown an image of a tree, a person, a beachball and a car. If the user decided to imagine a story concerning a beachball, the user would indicate the beachball via the Input Device, which could be a computer mouse or a touchscreen on top of the monitor or switches adjacent to the User Output Device. The signal from the Input Device would be sent to a Logic Unit, which in accordance with its Program Memory, would then display a different set of images on the screen, ie, the User Output Device. To continue the above example a beach umbrella, a beach chair, a picnic basket and water float are displayed now. If the user now imagined the story such that he or she was taking his or her beachball to the beach and then sit down to have a picnic lunch, then the user would indicate the image of the picnic basket. The signal from the Input Device would be sent to a Logic Unit, which in accordance with its Program Memory, would then display a different set of images would be on the screen, ie, the User Output Device. To continue the above example a sandwich, a banana, an apple and a softdrink would be displayed on the screen. If the user now imagined the story such that he or she was eating the sandwich, then the user would indicate the image of the sandwich. The selection of the beachball, picnic basket and sandwich, in this simple example, would represent the user's password. Signals in a set of ‘Scene Registers’ would represent these three event images, ie, in this case in Scene Register 1 would be a code representing the beachball, in the Scene Register 2 would be a code representing the picnic basket and in the Scene Register 3, would be a code representing the sandwich. Unlike alphanumeric passwords or static or other images, these type of graphical event-based passwords tend to be readily learned and retained for long periods of times by users.

In the example above the user has specified what his/her password should be. The values in the Scene Registers would be passed via an Interface Box to a computer system or other electronic registers that would store these values or a representation thereof. In some embodiments, the storage could actually be performed locally by the Logic Unit and Program Memory other other memory. The next time the user accesses the machinery or computer system utilizing this password system, the user would make choices via the Input Device as he/she did above. The values in the Scene Registers would be passed via an Interface Box to a computer system or other electronic registers that would compare these values with the values stored originally when the user specified his/her password. (Or in some embodiments, such data retrieval and comparison could be performed locally by the Logic Unit and Program Memory.) If the values compared accurately enough for purposes of the said computer system or other electronic registers, then the user could be, for example, permitted to use the particular machinery or computer system for which the user submitted his/her password.

### BRIEF DESCRIPTION OF THE DRAWINGS

FIG. 1 is a block diagram of a processing system that includes a preferred embodiment of the invention;

FIG. 2 is a schematic diagram of images that could be, in one of many embodiments, be displayed initially on the User Output Device;

FIG. 3 is a schematic diagram of images that could be displayed, in one of many embodiments, at a later time on the User Output Device;

FIG. 4 is a schematic diagram of images that could be displayed, in one of many embodiments, at a later time on the User Output Device;

### DESCRIPTION OF PREFERRED EMBODIMENTS AND PRACTICES

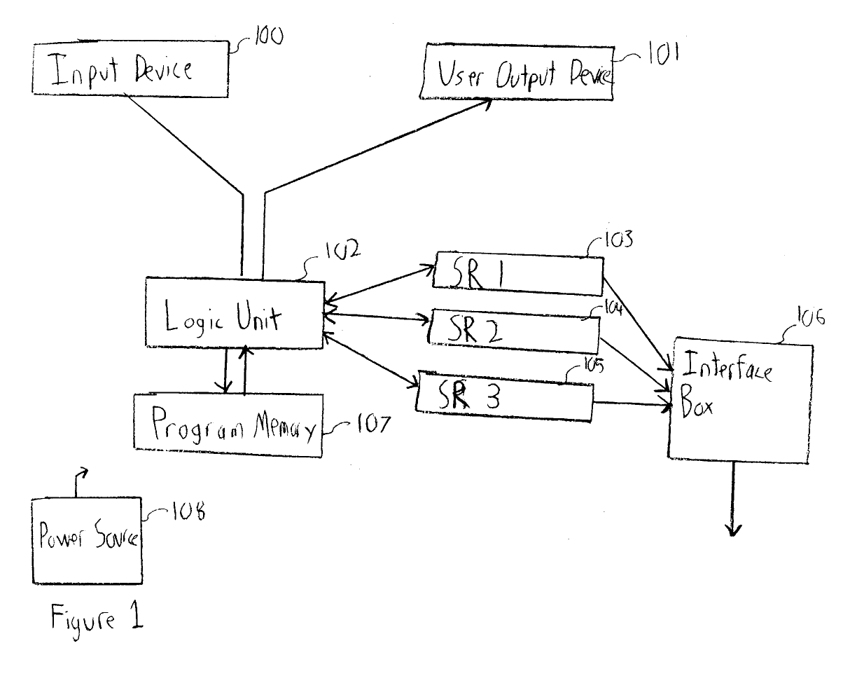

FIG. 1 shows a block diagram of a processing system that includes a preferred embodiment of the invention.

The Input Device 100 may be a keypad, a keyboard, a computer mouse, a series of switches on the edges of a monitor, a touchscreen, a voice-to-character input device, or other such input devices. The User Output Device 101 may be a computer monitor, LED displays, specialized touchscreen monitor, or other such output devices.

Logic Unit 102 consists of electronic registers which function in accordance to commands stored in a Program Memory 107. The Logic Unit 102 and corresponding Program Memory 107 may be a full personal computer, a single-chip microcomputer, an embedded computer, an industrial controller or other such logic unit/program memory devices.

SR1 (Scene Register1) 103, SR2 (Scene Register2) 104, and SR3 (Scene Register3) 105 are memory registers which are used to hold a code representing an image selected by the user. The Scene Registers 103, 104 and 105 may be standard dedicated semiconductor random-access-memory, or may be indirectly stored on the magnetic hard drive or other storage medium, may be squeezed into the Program Memory 107 or may be squeezed into memory internal or external to the password system. The Logic Unit 102 is usually responsible for reading and writing values to/from the Scene Registers 103, 104, and 105, as well as controlling the reading and writing of these Scene Registers 103, 104 and 105 by the Interface Box 106.

The Interface Box 106 allows the contents of the Scene Registers 103, 104 and 105 to be read or written by an external computer system or electronic device. This is the case when the preferred embodiment of the present invention is being used as a password input device essentially, and another external computer system is the one which actually knows the user's password. However, many embodiments of the present invention are possible. In some embodiments, no external computer system will be used, ie, the users' passwords will be stored in a local memory that is accessible by the Logic Unit 102.

A Power Source 108 is required to provide electrical power to the other components of FIG. 1. The Power Source 108 may be a power supply attached to the main electrical outlet, batteries, or other similar electrical power source.

The preferred embodiment of the present invention, as shown in FIG. 1, could be used in many situations where password entry is required. For example, consider the example where a password (or ‘PIN’) is required by an automatic teller machine (or ‘ATM’). Before the ATM will disperse funds to the user, it requires that the user enter an appropriate PIN so that it is indeed the user, and not someone else, using his/her bank card.

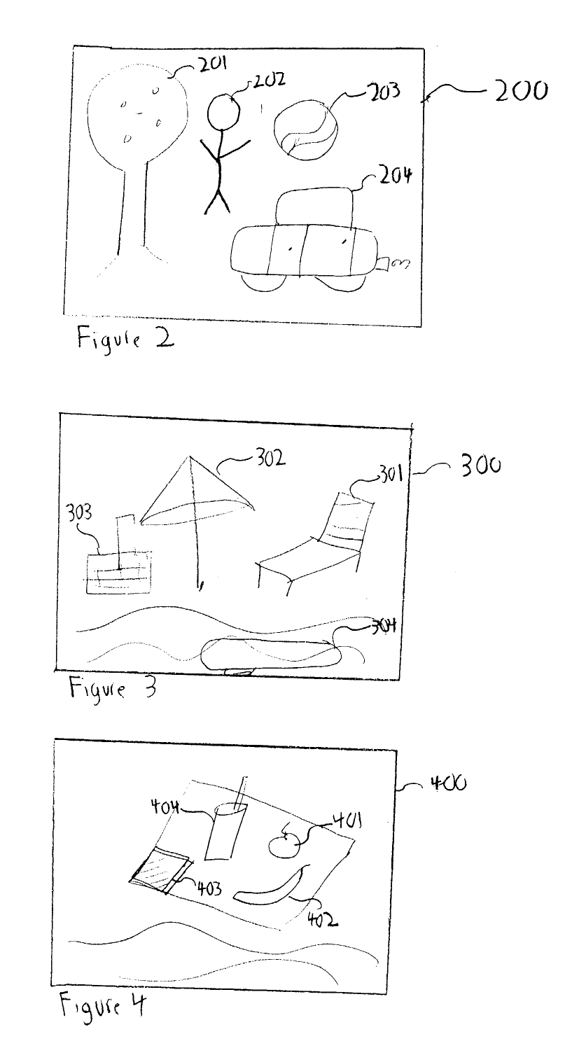

To continue this example where the preferred embodiment of the present invention is employed within an ATM, the first time a user uses the system, he/she must set a password. On the User Output Device 101, typically a computer monitor, the user is shown a group (or series) of images. The user is prompted to chose an image and imagine a story concerning that image. For example, the user could initially be shown an image of a tree 201, a person 202, a beachball 203 and a car 204, as shown in FIG. 2. If the user decided to imagine a story concerning a beachball, the user would indicate the beachball 203 via the Input Device 100, which could be a computer mouse or a touchscreen on top of the monitor or switches adjacent to the User Output Device 101. The signal from the Input Device 100 would be sent to a Logic Unit 102, which in accordance with its Program Memory 107, would then display a different set of images on the screen, ie, the User Output Device 101. To continue the above example a beach umbrella 302, a beach chair 301, a picnic basket 303 and water float 304, as shown in FIG. 3, are displayed now. If the user now imagined the story such that he or she was taking his or her beachball to the beach and then sit down to have a picnic lunch, then the user would indicate the image of the picnic basket 303. The signal from the Input Device 100 would be sent to a Logic Unit 102, which in accordance with its Program Memory 107, would then display a different set of images would be on the screen, ie, the User Output Device 101. To continue the above example a sandwich 403, a banana 402, an apple 401 and a softdrink 404, as shown in FIG. 4, would be displayed on the screen. If the user now imagined the story such that he or she was eating the sandwich, then the user would indicate the image of the sandwich 403. The selection of the beachball 203, picnic basket 303 and sandwich 403, in this simple example, would represent the user's password. Signals in a set of ‘Scene Registers’ would represent these three event images, ie, in this case in Scene Register 1 103 would be a code representing the beachball 203, in the Scene Register 2 104 would be a code representing the picnic basket 303 and in the Scene Register 3 105, would be a code representing the sandwich 403.

In the example above the user has specified what his/her password should be. The values in the Scene Registers 103, 104 and 105 would then be passed via an Interface Box 106 to a computer system at the bank so that the bank's computer system could now store this password for this user. The next time the user uses one of the bank's ATM machines and identifies himself/herself (eg, typically by sliding or entering his/her bankcard into the the machine), on the User Output Device 101, typically a computer monitor, the user is shown a group (or series) of images. The user is prompted to chose an image which corresponds to the events in the story he/she previously created. The user could initially be shown an image of a tree 201, a person 202, a beachball 203 and a car 204, as shown in FIG. 2. In this example the user would choose the beachball 203. The signal from the Input Device 100 would be sent to a Logic Unit 102, which in accordance with its Program Memory 107, would then display a different set of images on the screen, ie, the User Output Device 101. To continue the above example a beach umbrella 302, a beach chair 301, a picnic basket 303 and water float 304, as shown in FIG. 3, are displayed now. In this example, the user would choose the picnic basket 303. The signal from the Input Device 100 would be sent to a Logic Unit 102, which in accordance with its Program Memory 107, would then display a different set of images would be on the screen, ie, the User Output Device 101. To continue the above example a sandwich 403, a banana 402, an apple 401 and a softdrink 404, as shown in FIG. 4, would be displayed on the screen. The user would now choose the sandwich 403. For the sake of brevity here is only listed three sets of images. However, in actual embodiments there would likely be more that three sets of images. As well, within each set of images, there would likely be more than just a few images to choose from. In doing so, the sample space of the password is increased. For example, a PIN password for an ATM banking machine typically has a sample space of 10,000 passwords (ie, 0000 to 9999).

Continuing the example above, signals in the set of ‘Scene Registers’ 103, 104 and 105 would represent the three event images, ie, in this case in Scene Register 1 103 would be a code representing the beachball 203, in the Scene Register 2 104 would be a code representing the picnic basket 303 and in the Scene Register 3 105, would be a code representing the sandwich 403. Via the Interface Box 106 these codes in the Scene Registers 103, 104 and 105, would be transmitted, to continue the example above, to the bank's computer. The bank's computer would compare these codes from Scene Registers 103, 104 and 105, with codes that the bank's computer originally received when the user was setting his/her password. In this example, if the codes successfully match, then the bank's computer would send a signal back to the ATM banking machine (or possibly Logic Unit 102 if it was being used for other functions inside the ATM) instructing the ATM banking machine that the password was successfully entered, and thus the user would be allowed to continue with his/her banking functions.

In the above example, an embedded computer within a banking machine and separate bank computer was considered. However, in other embodiments of the current invention, their may only be a single computer being used, and the Logic Unit 102 may lie within in it. For example, if an embodiment of the present invention was being used to restrict access to a personal computer, then, the Logic Unit 102 would effectively be within the CPU of the personal computer and the Scene Registers 103, 104, and 105 would be within the RAM of the computer with permanent storage in the personal computer's hard disk drive, and the Interface Box 106 would not be required.

It is possible to envision embodiments of the present invention where virtual use of registers are made. For example, if 20 Scene Registers are required to enter 20 selected images, it is possible to make use of a single Scene Register, but after it is loaded with a code representing a selected image, to check this code against the stored code representing the user's initial setting, and if it does not match, flag a register indicating the the password being entered is not correct.

Many possible changes and modifications to the illustrative embodiment shown above will be apparent to those skilled in the art. Such changes and modifications can be made without departing from the essence and scope of the present invention, and should not diminish its advantages. Thus, it is intended that the claims below cover such possible changes and modifications.

I claim:

1. An event-based graphical password system comprising:
a display;
first means, responsive to the initial request of the user, for displaying on the display a set of images;
second means, that allows the user to indicate selection of particular image of the set of images on said display;
a logic unit;
a first memory register to hold a code representing the first image selected and accessible by said logic unit;
a second memory register to hold a code representing the second image selected and accessible by said logic unit;
a third memory register to hold a code representing the third image selected and accessible by said logic unit;
third means that forwards the contents of said first, second and third memory registers to another memory device or to another computer system where the contents of the said first, second and third memory registers represent the password chosen by the user;
a program memory accessible by said logic unit holding a stored computer program which causes the logic unit to respond to the user's initial image selection by displaying a second set of images, and which in turn responds to the user's second image selection by displaying a third set of images.

2. The system of claim 1 wherein:
said logic unit lies within the central processing unit of another computer.

3. The system of claim 1 wherein:
said memory registers lie within the random access memory of another computer.

4. The system of claim 1 wherein:
said second means is a computer keyboard.

5. The system of claim 1 wherein:
said second means is a computer mouse.

6. The system of claim 1 wherein:
said second means is a touchscreen.

7. A method of an event-based graphical password system for setting passwords comprising the steps of:
in response to a start-program condition or to an initial request of a user, displaying to the user one or more images;
selecting an image based on a story event the user has imagined;
in response to the selected image, displaying to the user one or more different images;
selecting another image based on the events of a story the user has imagined;
in response to the selected second image, displaying to the user one or more different images;
selecting a third image based on the events of a story the user has imagined;
in response to the selected third image forwarding the codes stored in three memory registers representing the selected images to another memory location.

8. The method of claim 7 wherein:
there are selection of additional images.

9. The method of claim 7 wherein:
in response to the selected third image checking the contents of the codes stored in the said three memory registers against codes representing the images originally chosen by the user.

10. The method of claim 7 wherein:
in response to each image there is checking of the contents of the code stored in the said memory register against the codes representing that particular image originally chosen by the user and doing so in response to each image.
